(19) United States
(12) Patent Application Publication
(10) Pub. No.: US 2019/0379651 A1
(43) Pub. Date: Dec. 12, 2019

(54) System and method for providing remote check-in services

(71) Applicant: 10526274 Canada Inc., Montreal (CA)

(72) Inventor: Jean-Francois Letendre, Montreal (CA)

(21) Appl. No.: 16/439,203

(22) Filed: Jun. 12, 2019

Related U.S. Application Data
(60) Provisional application No. 62/683,676, filed on Jun. 12, 2018.

(51) Int. Cl. H04L 29/06; G06Q 10/02

(52) U.S. Cl. CPC H04L 63/083; G06Q 10/02

(57) ABSTRACT

A system and method for providing remote check-in services are described. The system comprises at least one intelligent device for the visitors, at least one intelligent device for the receptionists, a processor device, and an indication device. The two intelligent devices are connected by a WAN (world area network). The method comprises that a guest logs in an application to update his/her account information, the guest calls a host via the application; the host receives the call and verifies the personal information of the guest; and if the verification is ok, the host allows the guest to enter the premises.

### CROSS-REFERENCE TO RELATED APPLICATIONS

The present patent application claims the benefits of priority of U.S. Provisional Patent Application No. 62/683,676, entitled “Systems and methods for providing remote check-in services”, and filed at the US Patent Office on Jun. 12, 2019, the content of which is incorporated herein by reference.

### FIELD OF THE INVENTION

The present invention generally relates to a remote identification control system, and more particularly to a virtual check-in system configured to identify and validate some necessary information.

### BACKGROUND OF THE INVENTION

Nowadays, some web based premise rental systems are popular which incite many person to have the possibility to make a rental transaction. Take the Airbnb™ system for example. Visitors use the web platform to book rooms and hosts accept their reservations. When the visitor arrives at the room, generally the hosts often must actually meet the visitor in person to give the keys of the room to the visitors. Another example is a tradition hotel reception system, the receptionist is always in the check-in to welcome the visitors and verifies the personal information of the visitors before giving access to the room.

Other times, the keys to the premises are placed in a container which is locked with a combination lock or a remotely controlled lock. However, in such cases, there is usually no direct visual contact between the host and the visitor. In the event the visitor damages the premises or steals items from the premises, it is difficult for the host to prove and claim the resulting damages

It is obvious that traditional visitors and hosts recognition systems are inefficient and time-consuming, because the hosts must actually wait for the visitors and meet them face-to-face.

Thus, there is a need to invent a new visitor and host greeting system to overcome the above problems. The Virtual Front Desk™ was invented out of the necessity to provide an efficient and secure mean of checking in guests for the vacation rental industry or any other business sectors where a remote greeting system could be beneficial. Contrary to the regular hotels who control arrivals and departures from their physical check-in, most vacation rental hosts will have to physically meet their guests at their address to hand over keys or provide a door entry code based on personal information provided online by the guest. The situation creates many kinds of security issues along with being inefficient and time consuming for both hosts and guests.

### SUMMARY OF THE INVENTION

The shortcomings of the prior art are generally mitigated by providing systems and methods for providing remote check-in services.

A system and method to provide remote identification, documentation, signature, information and facility access management through a remote Virtual Front Desk™ at a remote location comprise a visitor data entry computer, a mobile phone or tablet including a processor and a camera to capture images of the guests and IDs of the guests, a display to show the remote receptionist and other information to the guest, a touch screen to capture the visitor and or remote receptionist's actions, a speaker and a microphone to reproduce verbal communication between the remote receptionist and the visitor.

In some embodiments, the system for providing remote check-in, comprises a processor device connected to an application located on at least two intelligent devices via the internet; an intelligent device is used by a first person while another intelligent device is used by a second person; the first person sends different information via the application and the second person receives the information from the first person, and the second person engages the communication with the first person via the application and verifies the personal information of the first person.

In a preferable embodiment, a system for providing remote check-in services generally comprises at least one Personal Computer Message Terminal (PCMT) for the visitor, at least one PCMT for the receptionist, a processor device, and an indication device. PCMT and PCMT are connected by a world area network (WAN). For the purposes of this description, PCMT generally means PC, Mobile phone or Tablet which includes a processor, a camera to capture images and IDs of the visitor, a display to show the remote receptionist to the visitor and vice-versa and information, a touch screen to capture the visitor's and/or remote receptionist's actions, a speaker and microphone to reproduce verbal communication between the remote receptionist and the visitor.

In some embodiments, the system further comprises an indication device configured to output a checking result to the touch screen in response to the verification step.

Another object of the present invention is to supply a method for providing remote check-in services established between at least two intelligent devices via a processor device and the internet, comprising the first person log-ins to an application to update its account information; the first person calls the second person via the application; the second person receives the call and verifies the personal information of the first person; and if the verification is ok, the second person allows the first person to get to the further page of the application to get further information.

In a preferable embodiment, the first person is a guest, the second person is a host, and the further information is virtual concierge information, including a door opening code.

In some embodiments, the guest updates its account information comprising filling in a profile, uploading IDs and taking a selfie; the host receives the call and verifies the personal information of the first person comprising a video conversation and matching guest's selfie and IDs; the host receives the call and verifies the personal information of the first person further comprising the host verification of the guest and the guest agreeing and signing the terms and conditions.

In another embodiment, if the verification is ok, the host allows the guest to get to the further page of the application to a virtual concierge home page comprising a door lock code, a welcome note, the Wi-Fi information and the terms and conditions signed at check in. The application further comprising icons menu to get some detailed information and some links to outer web page.

In some embodiments, the host could modify the web information about its listing.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a schematic representation of a system for providing remote check-in services in accordance with the principles of the present invention;

FIGS. 2A-2C are examples of log-in web pages of the application in accordance with the principles of the present invention;

FIGS. 3A-3D are examples of guests updating their account information web pages of the application in accordance with the principles of the present invention;

FIGS. 4A-4D are examples of part of guest views of the check-in procedure web pages in accordance with the principles of the present invention;

FIGS. 5A-5E are examples of another part of guest views of check-in procedure web pages in accordance with the principles of the present invention;

FIGS. 6A-6D are examples of part of host views of check-in procedure web pages in accordance with the principles of the present invention;

FIGS. 7A-7E are examples of another part of host views of check-in procedure web pages in accordance with the principles of the present invention;

FIGS. 8A-8K are examples of guest views of virtual concierge web pages in accordance with the principles of the present invention;

FIGS. 9A-9M are examples of host listing set up, terms and conditions, icon menu set up web pages in accordance with the principles of the present invention; and

FIGS. 10A-10C are examples of chat box web pages in accordance with the principles of the present invention.

### DETAILED DESCRIPTION OF A PREFERRED EMBODIMENT

A novel system and method for providing remote check-in services will be described hereinafter. Although the invention is described in terms of specific illustrative embodiments, it is to be understood that the embodiments described herein are by way of example only and that the scope of the invention is not intended to be limited thereby.

System and method to provide remote identification, documentation, signature, information and facility access management through a remote virtual check-in at a remote location and a visitor data entry computer, a mobile phone or tablet including a processor, a camera to capture images and IDs of the visitor, a display to show the remote receptionist to the visitor and the information, a touch screen to capture the visitor's and/or remote receptionist's actions, a speaker and microphone to reproduce verbal communication between the remote receptionist and the visitor.

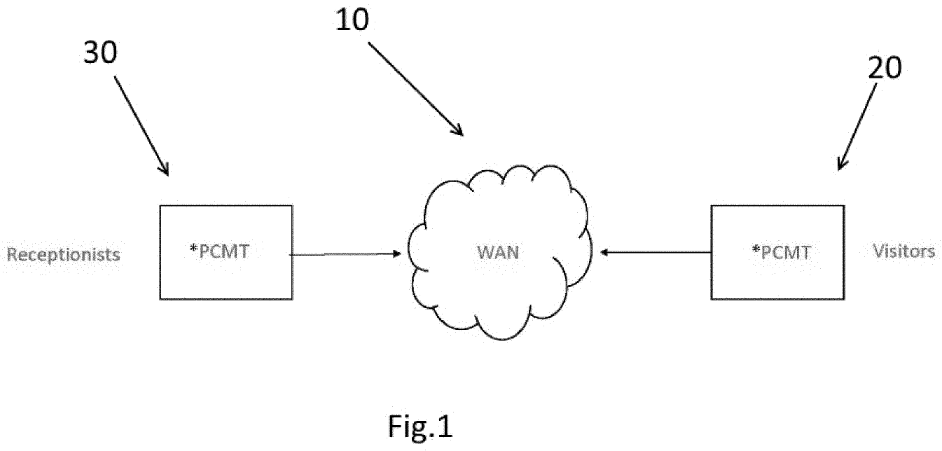

Now referring to FIG. 1, a system for providing remote check-in services 10 generally comprises at least one PCMT 20 for the visitors, at least one PCMT 30 for the receptionists, a processor device (not shown in the figure), and a display device (not shown in the figure). PCMT 20 and PCMT 30 are connected by a WAN. PCMT generally means a PC, Mobile phone or Tablet which includes a processor, a camera to capture images and IDs of the visitor, a display to show the remote receptionist to the visitor and the information, a touch screen to capture the visitor's and/or remote receptionist's actions, a speaker and microphone to reproduce verbal communication between the remote receptionist and the visitor.

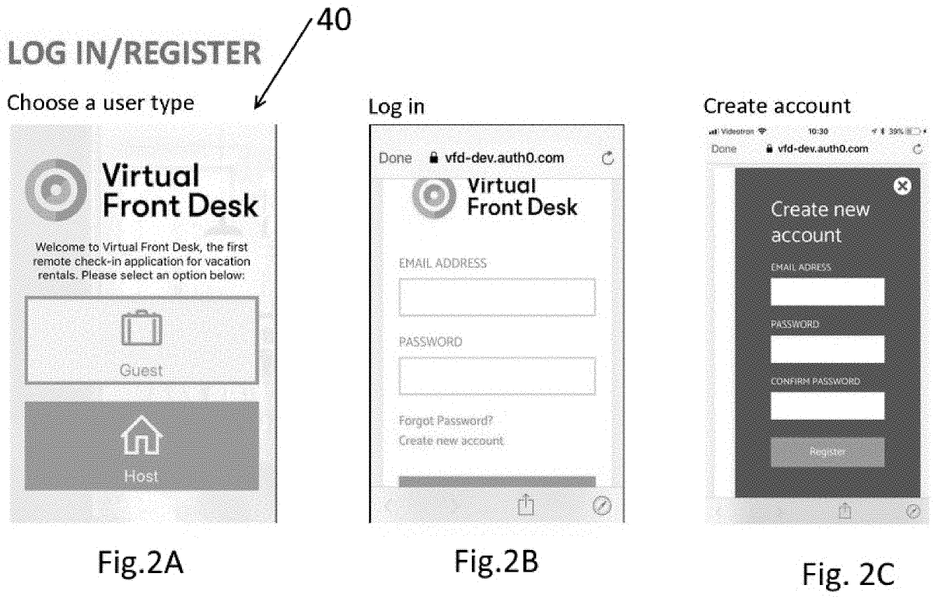

Now referring to FIGS. 1-2, a virtual check-in 40 software is installed on the PCMT 20, 30 where it processes and records image and video materials. The receptionist (host) is the user receiving the information from a visitor (guest). The guest engages the communication with the host via the virtual check-in system 40 using PCMT 20, 30. A series of actions triggered by both host and guest will complete the check-in procedures.

Now referring to FIG. 2, the virtual check-in system 40 is shown. Before applying the remote check-in services, each participant will have to download the software virtual check-in system on an intelligent device, such as PCMT. FIG. 2A shows the first page of the software which concerns the selection of a user type: guest or host. FIGS. 2A and 2B show the user creating a new account and logging in the account.

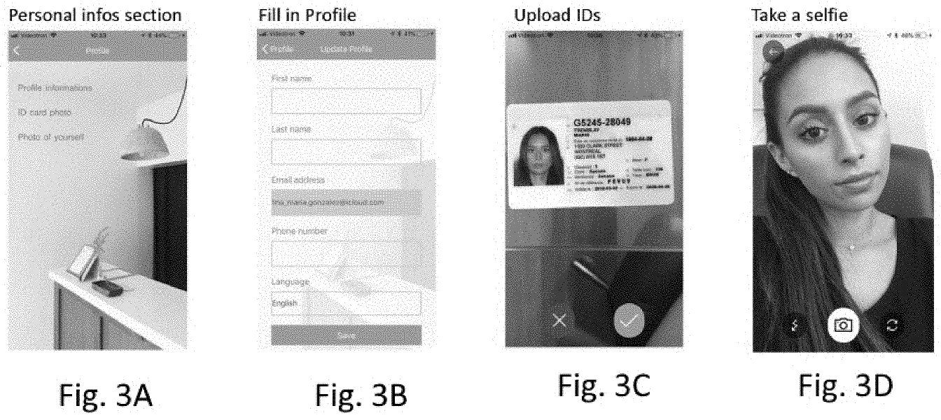

Now referring to FIGS. 3A-3D, in this section both host and guest update their account information in order to use virtual check-in. The profile is entered, including some personal information (as shown in FIG. 3B), such as but not limited to first name, last name, email address, phone number and language, secondly upload IDs (as shown in FIG. 3C), and thirdly take a selfie to upload to the system (as shown in FIG. 3D).

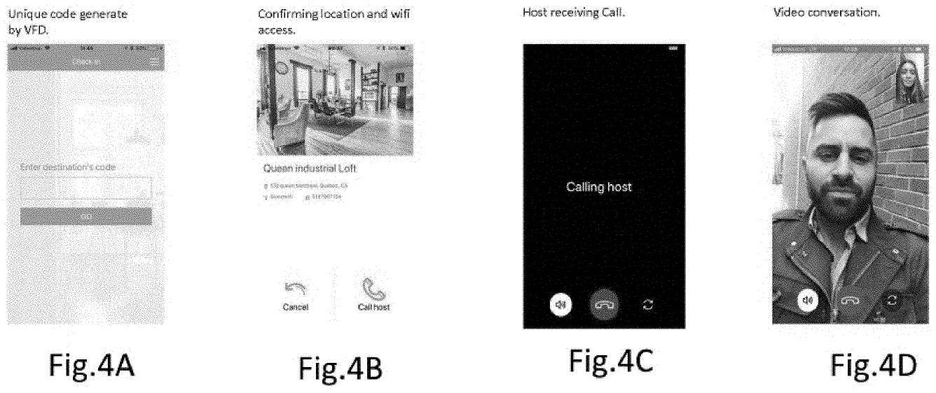

Now referring to FIGS. 4A-4D, in this section, the guest enters the unique destination code created by the virtual check-in system which is linked to the host's apartment (like a phone number). The host will receive a video call enabling the host to identify the guest, make him/her sign his terms & conditions and give him access to the concierge section before he/she enters the house. FIG. 4A shows an example of an interface for the guest entering the unique destination code created by the virtual check-in system which is linked to the host's apartment. FIG. 4B shows an interface for confirming location and Wi-Fi access when the guest enters a destination code. Then the guest validates the destination, if yes, call host, if no, cancel and find a correct destination code to repeat the above procedures. FIG. 4C shows the guest calling the host. FIG. 4D shows that the host receives the call and has a video conversation with the guest to check its personal information which audio and video are preferably stored in the system.

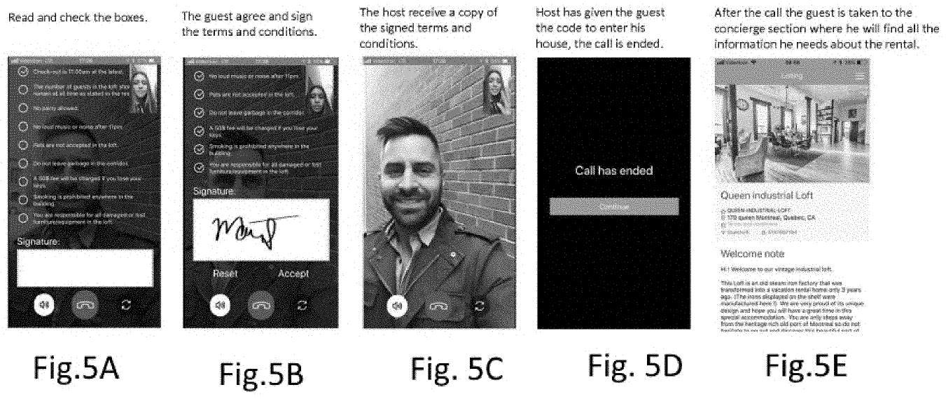

Now referring to FIGS. 5A-5E, a guest view of a check-in procedure is shown. FIGS. 5A-5B show a plurality of terms and conditions for the guest. After having read these terms and conditions, if the guest agrees with the terms and conditions, the guest signs. FIG. 5C shows the host receiving a copy of the signed terms and conditions. FIGS. 5D-5E show that, after the host has verified the guest personal information, the guest will receive the guest code to enter the rented premises and the call is ended. After the call, the guest is taken to the concierge section where he/she will find all the information he/she needs about the rental.

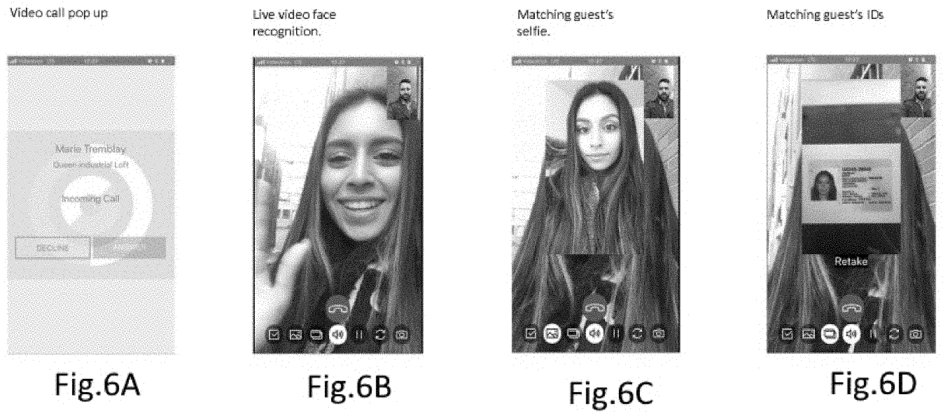

Now referring to FIGS. 6A-6D, a host view of a check-in procedure is shown. FIG. 6A shows that the guest receives a reminder information where there is an incoming call. FIGS. 6B-6D show the host verifying the guest personal information by live video face recognition, matching the guest's selfie, and matching the guest's IDS.

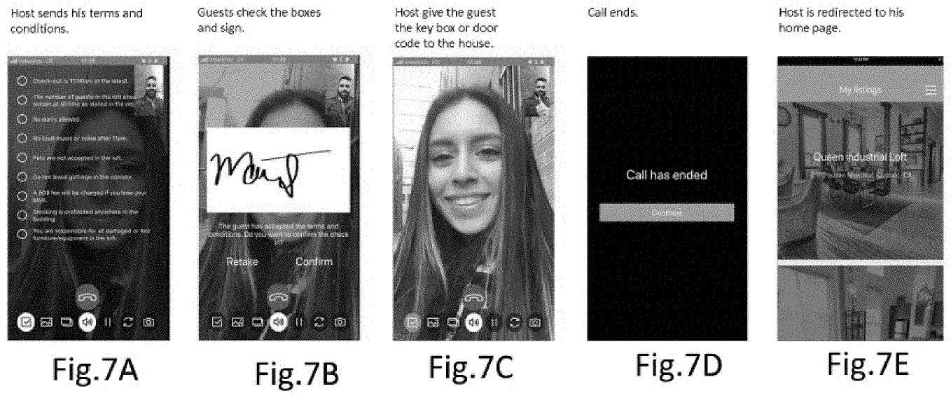

FIGS. 7A-7D are also part of the host view of the check-in procedure. Like the check-in procedure, the same sequence as in the guest view shown in FIGS. 5A-5E but from the host's perspective. FIGS. 7A-7B show that the host sends his/her terms and conditions to the guest and the guest checks the appropriate boxes and signs. FIGS. 7C-7D show that the host receives the signature of the guest and gives the guest the key box or door code to the premises, and then the call ends. FIG. 7E shows that the host is directed to his/her home page which is about some necessity information about the rental.

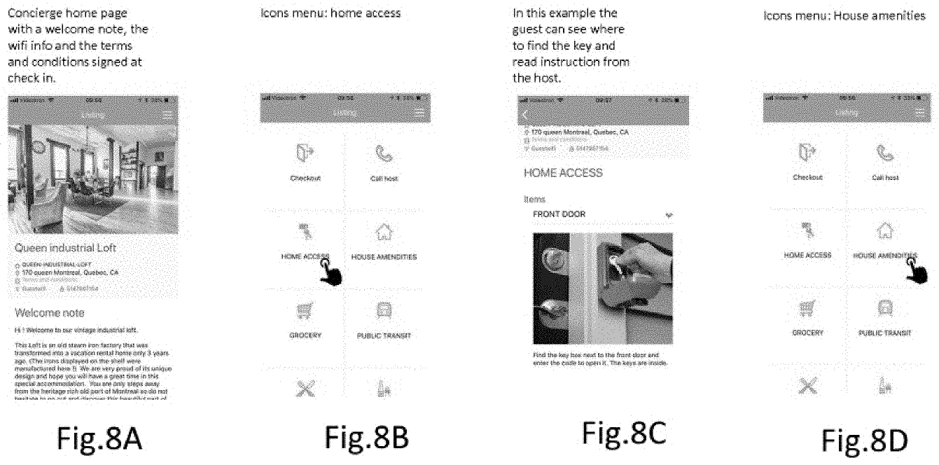

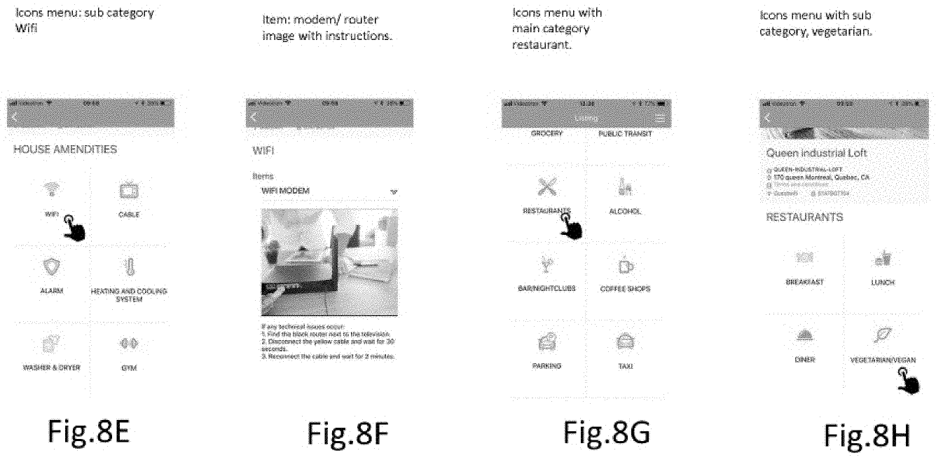

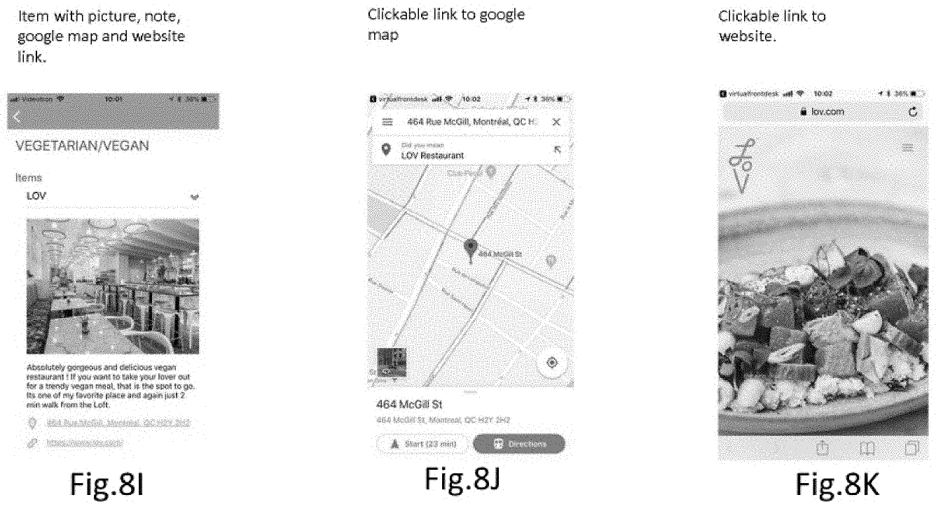

Now referring to FIGS. 8A-8K, a guest view of a virtual concierge is shown. The virtual concierge section allows the guest to access all the information in and out the house. FIG. 8A shows a concierge home page with a welcome note, the Wi-Fi information and the terms and conditions signed at check in. FIGS. 8B-8I show some icons menu in the virtual concierge page, such as home access where the guest can see where to find the key and read instruction from the host, house amenities, sub category Wi-Fi which comprises modem/router image with instructions, restaurant, vegetarian comprising pictures, notes, google maps and website links. Now referring to FIG. 8C, in this example the guest can see where to find the key and read instructions from the host. It is obvious known that smart locks could be used where the guest enters the room with a correct PIN supplied by the host with the application. Of course, if the room is managed by a property management system (PMS), the guest could enter the room by the help of a lock interface with some necessary information supplied by the host with the application. FIGS. 8J-8K show some clickable links to external webpages or external applications, such as google maps™, lov.com™.

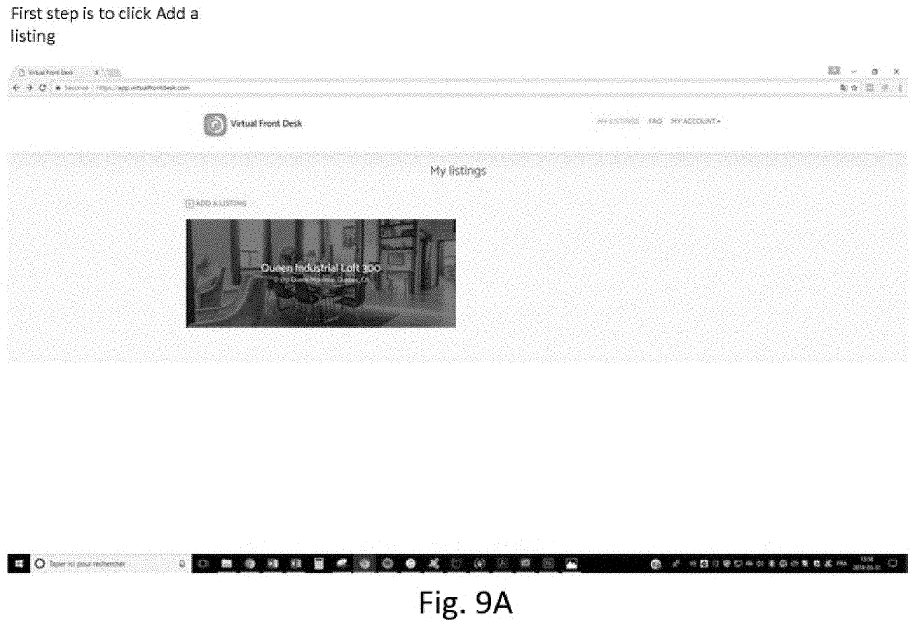

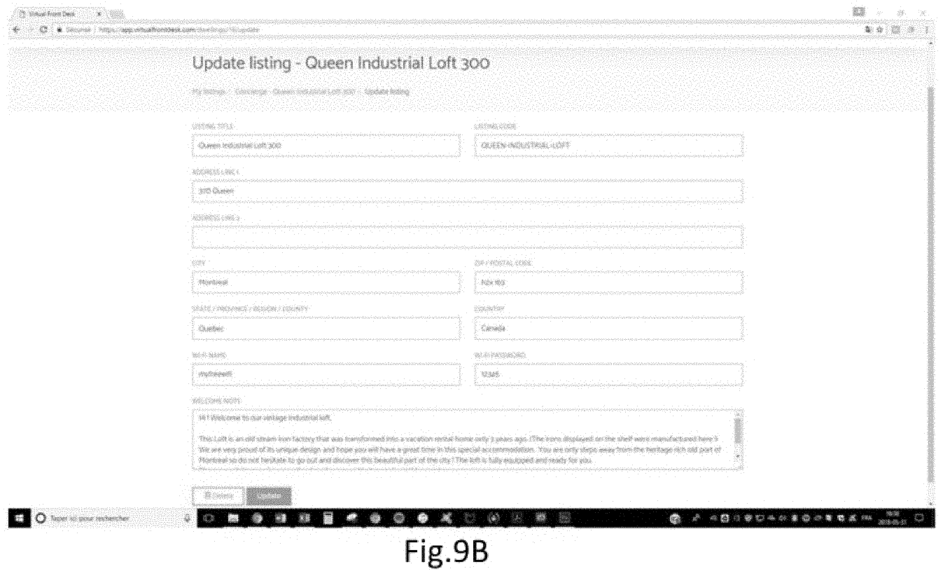

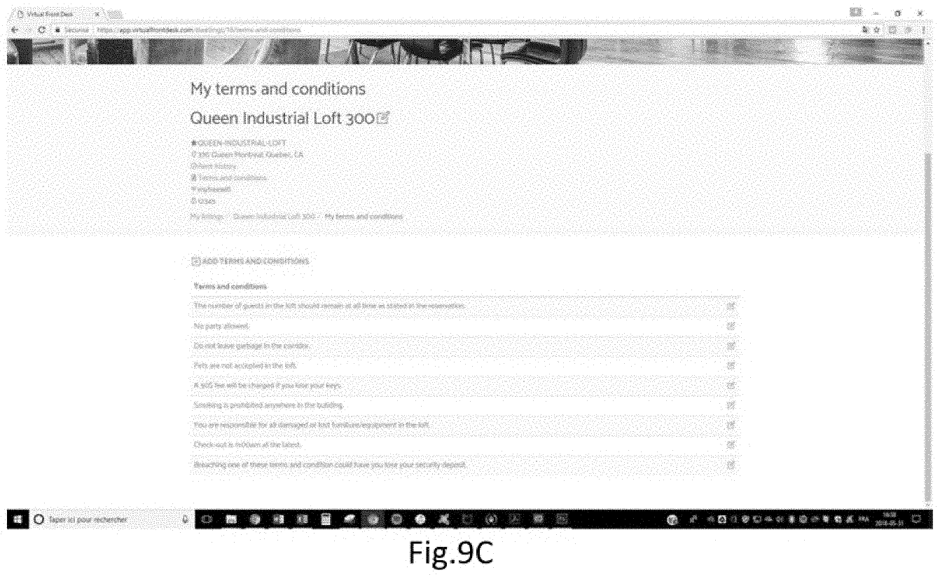

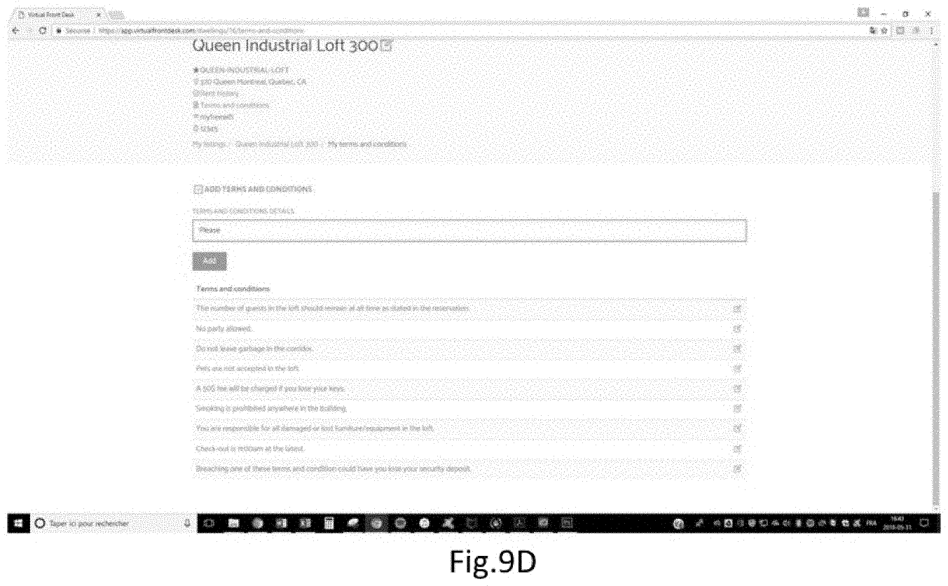

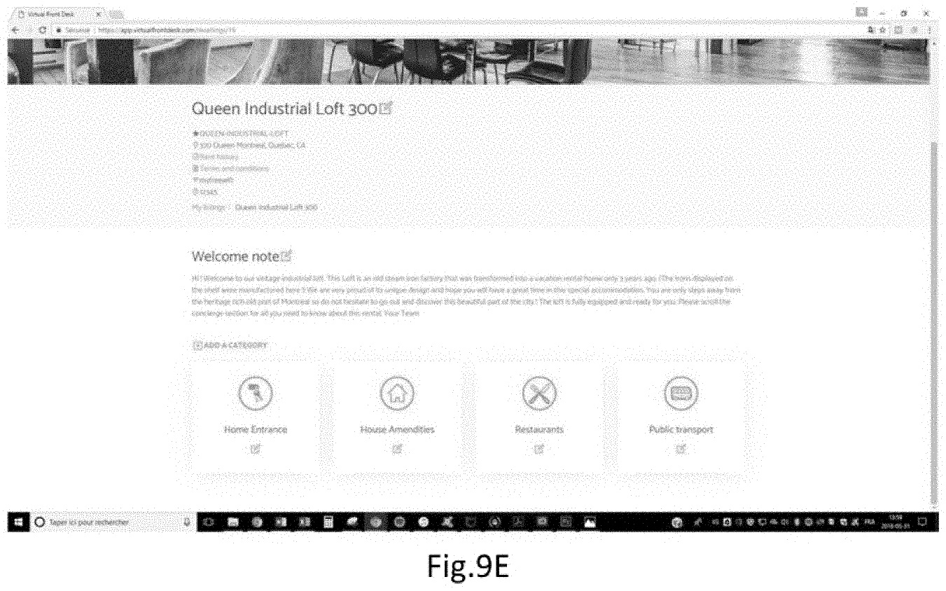

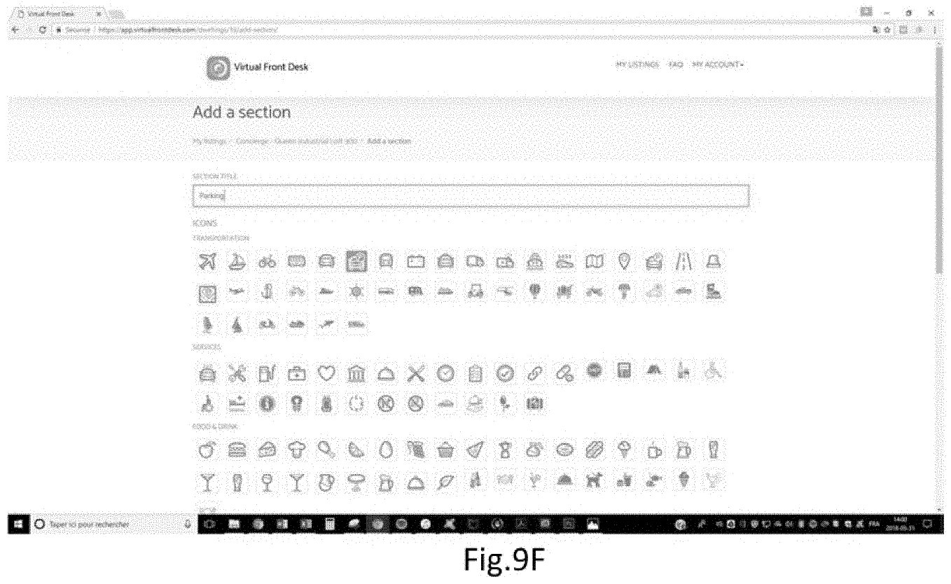

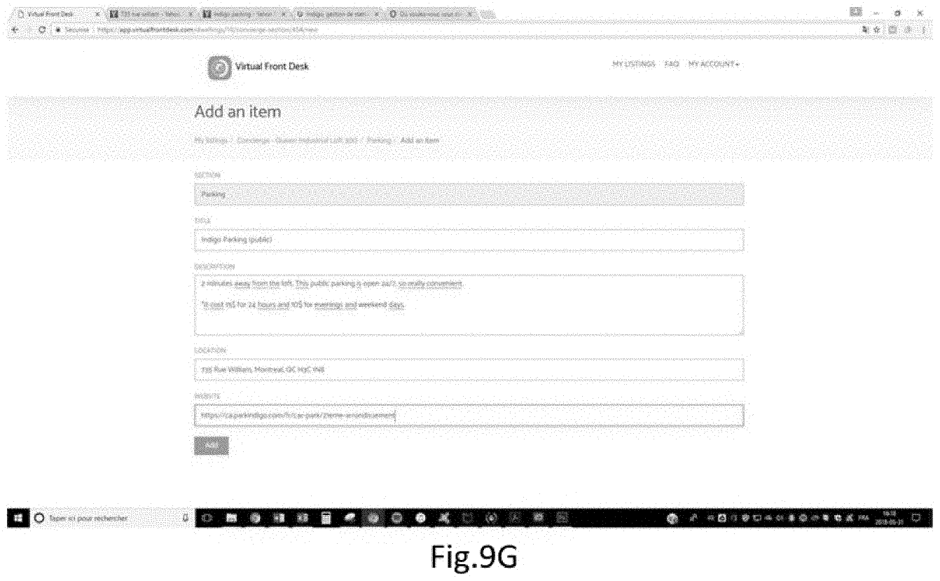

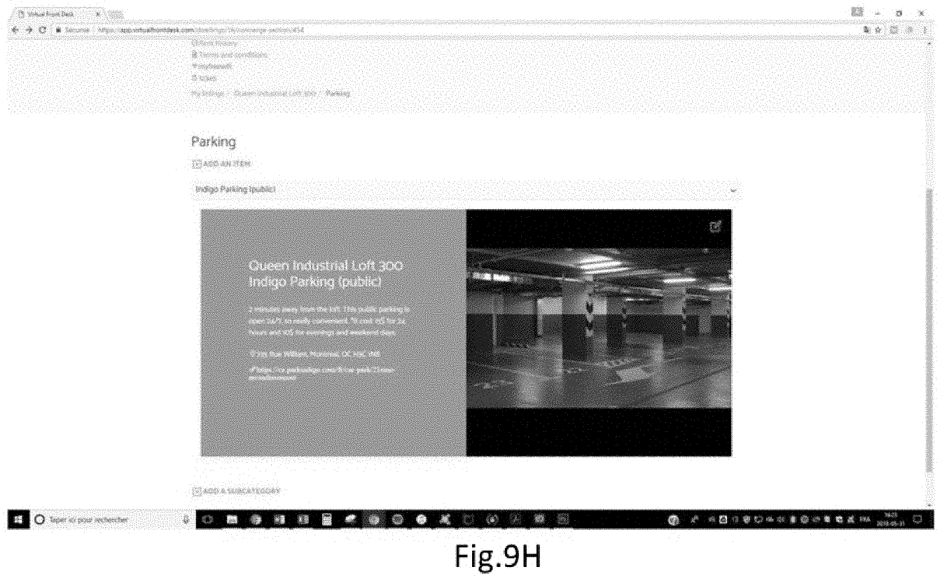

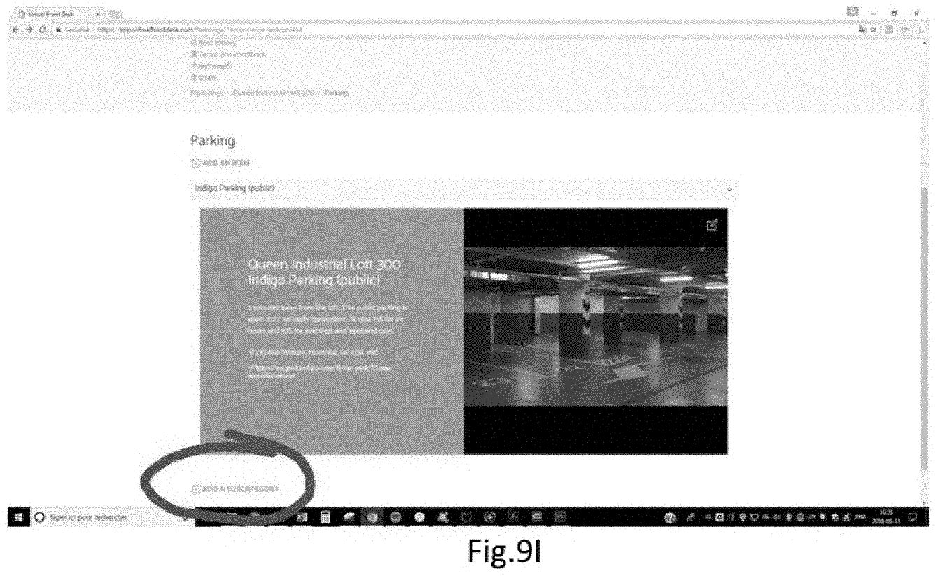

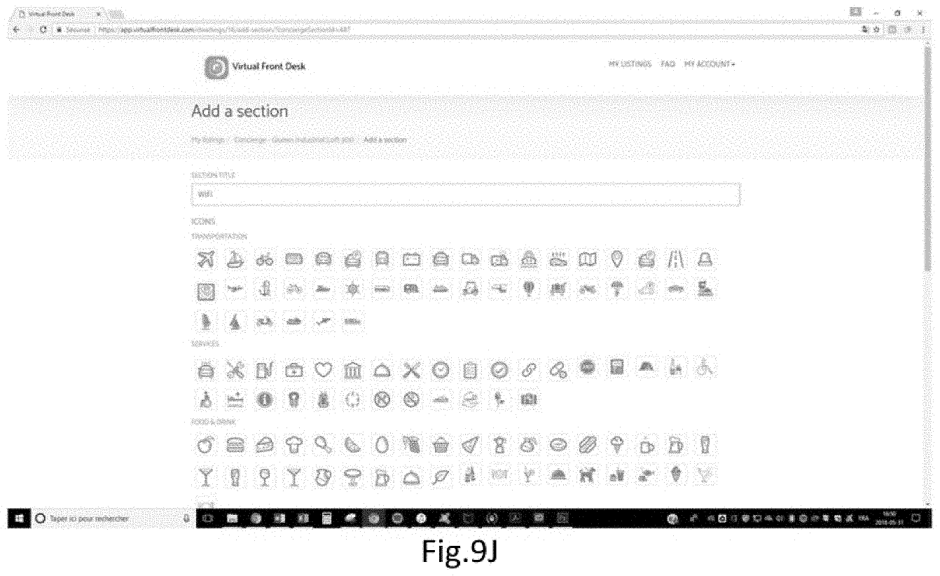

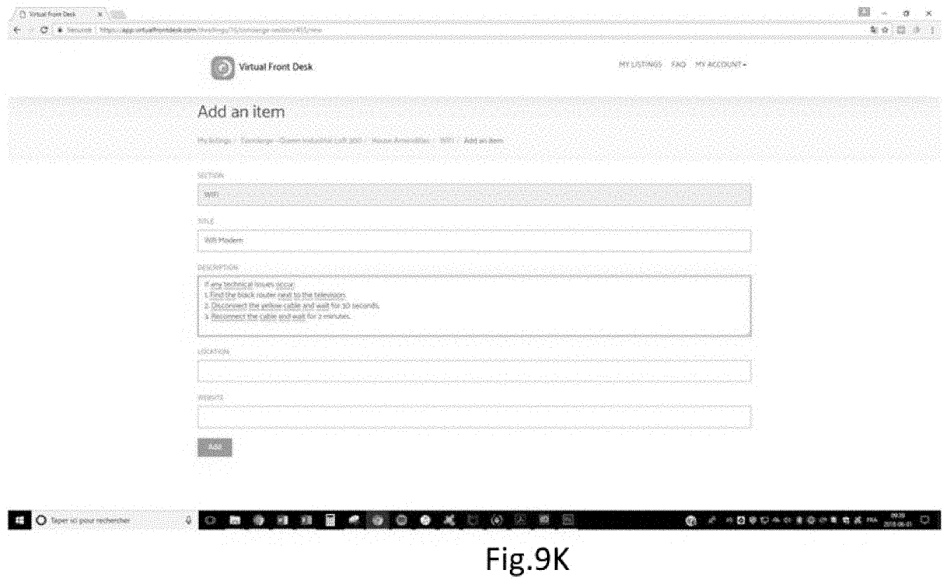

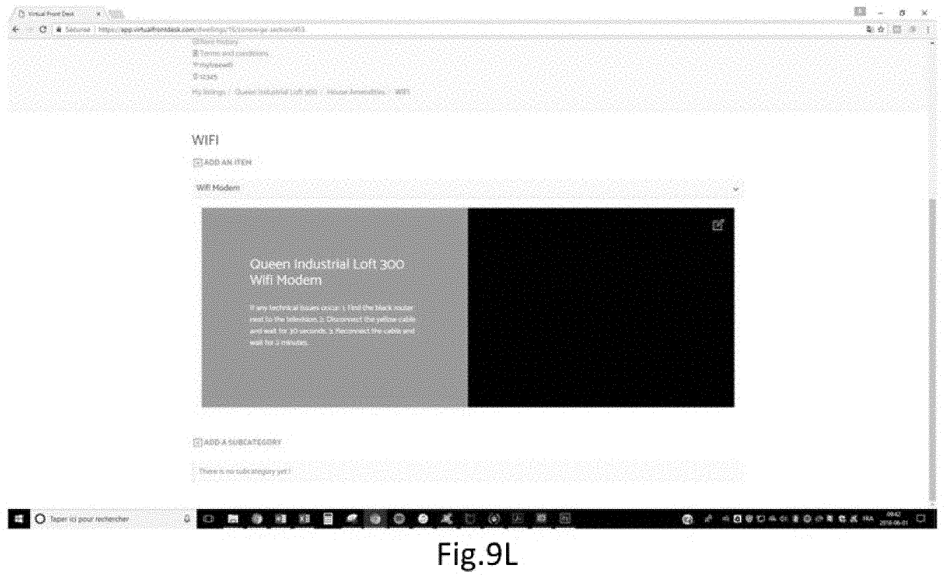

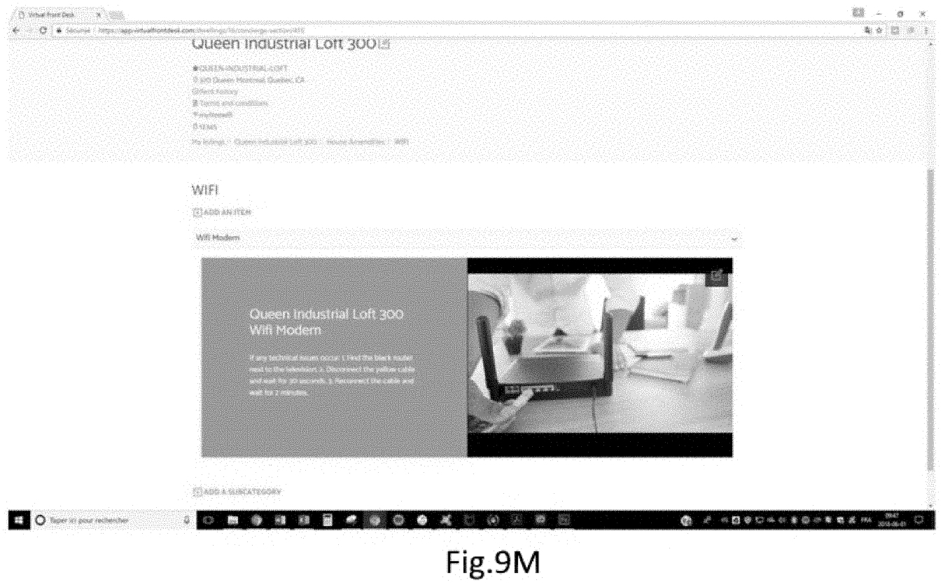

Now referring to FIGS. 9A-9M, a host listing set up webpage is shown. In order to create a listing, the host visits a web page, such as app.virtualfrontdesk.com to access the web base section of the app and fill in the information about his/her listing(s). Figure A shows a picture and some basic information about the rental. FIG. 9B shows that the host enters a listing name (for VFD to create a unique listing code) then a welcome note, the Wi-Fi and the address information. Once done the host can upload a picture of the rental. All this information will be available to the guest. FIGS. 9C-9D show that the host creates the terms and conditions document each guest will have to sign, in order to access the code to the door. FIG. 9E shows the host creating a category. It is to create a main category the host click on add a category. FIG. 9F also shows the host creating a category. The host enters the category's name, in this example, parking and picks an icon from the selection. FIG. 9G shows that the host creates an item. Once the category is created, the host either create a sub category or in this case, the item. The host gives a title, a description, the address (or google map™ link) and a website link the case may be. Click ADD to create the icon parking for all the guests to see. FIG. 9H also shows that during the creation of an item, to finish the host can add a picture of the item that the host just created. In FIGS. 91-9M, the method of creating a sub category is shown. To create a sub category inside a main category, for example Wi-Fi, in house amenities, the host clicks adds a subcategory under the add an item button. The host repeats the same steps as for creating a main category; chooses a title and picks an icon. Next the host, from that sub category, adds an item and fills in the information. Once the item is created and the information entered, the host uploads a picture of the item. Finally, the host now has an Icon called House amenities in which the host can find the sub category Wi-Fi with the item for all your guests to see.

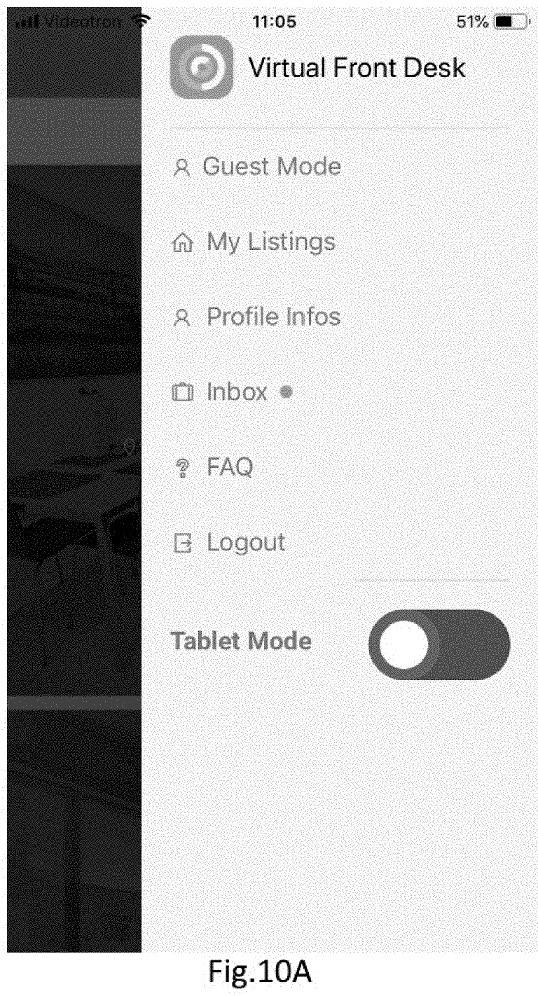

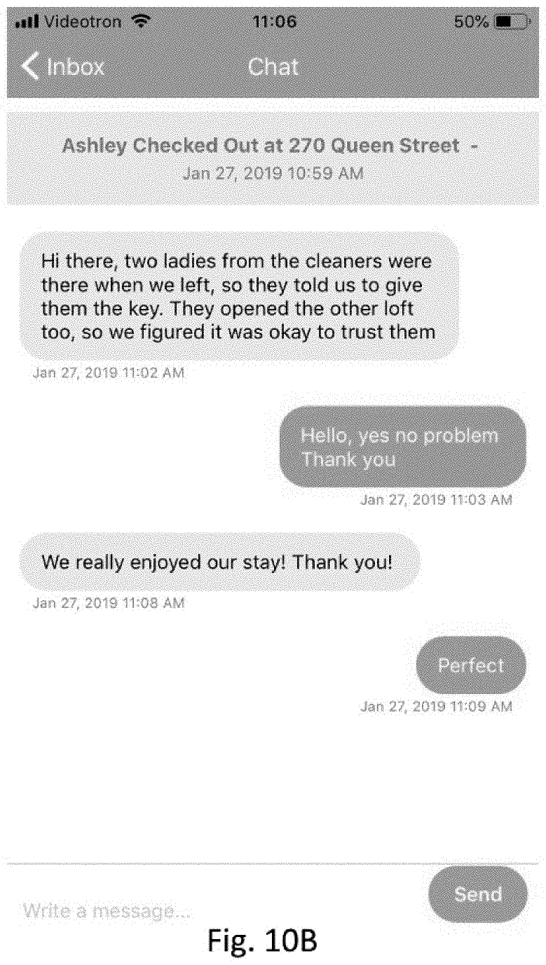

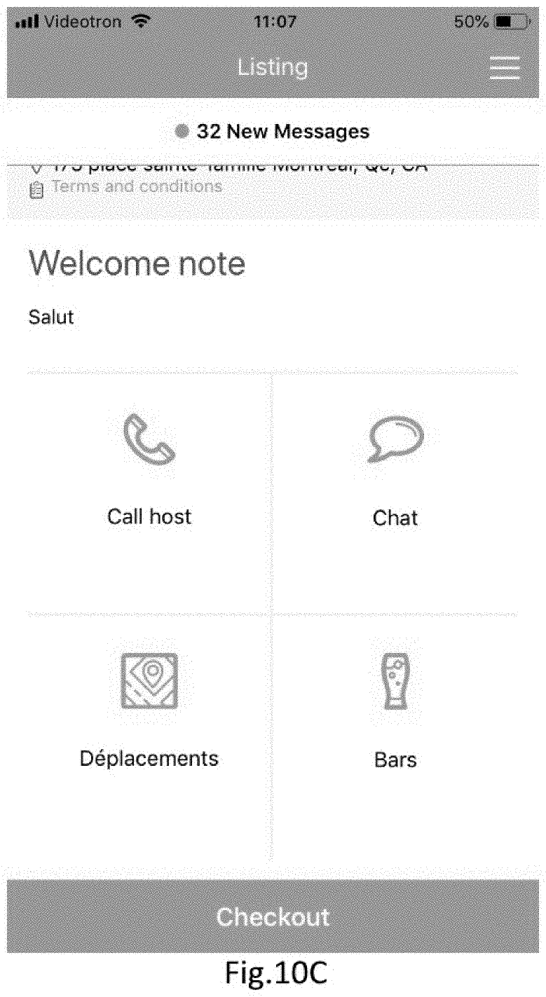

Now referring to FIGS. 10A-10C, a new chat box is shown. As described in FIG. 10A, when the guest or the host uses the virtual check-in application, there is a link Inbox. When the user receives a new message, the application will give the user a reminder. FIG. 10B is an example of messages in the chat box of a user and a host when the guest in a check out procedure. FIG. 10C shows the reminder of the application when the user receives new message.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. System for providing remote check-in services, comprising:
a processor device connected to an application located on at least two intelligent devices via the internet;
an intelligent device used by a first user;
another intelligence device used by a second user;
wherein:
the first user sends different information via the application and the second user receives the information from the first user,
the second user engages the communication with the first user via the application and verifies the personal information of the first user.

2. The system of claim 1, wherein the intelligent devices are selected from a mobile phone, a PC, or a tablet.

3. The system of claim 2, wherein the intelligent device comprises a camera to capture images of its user and of its user's photo ID.

4. The system of claim 3, wherein the intelligent device further comprises a speaker and a microphone to reproduce verbal communications between the two users.

5. The system of claim 4, wherein the intelligent device comprising a touch screen to capture the user's actions.

6. The system of claim 5, wherein the system further comprises a display device configured to output a checking result to the touch screen in response to the verification of the processor device.

7. Method for providing remote check-in services established between at least two intelligent devices via a processor device and the internet, comprising:
a first user logging in an application to update its account information;
the first user calls a second user via the application;
the second user receives the call and verifies the personal information of the first user;
if the verification is ok, the second user allows the first user to get to a further page of the application to get further information.

8. The method of claim 7, wherein the first user is a guest, the second user is a host, and the further information is virtual concierge information.

9. The method of claim 8, wherein the guest updates its account information comprising filling in a profile, uploading photo IDs and taking a selfie.

10. The method of claim 8, wherein the host receives the call and verifies the personal information of the guest comprising video conversation and matching the guest's selfie with the photo IDs.

11. The method of claim 10, wherein the host receives the call and verifies the personal information of the guest and the host verifies the guest has agreed to and signed predetermined terms and conditions.

12. The method of claim 8, wherein if the verification is ok, the host allows the guest to get to a further page of the application to a virtual concierge home page comprising a welcome note, the Wi-Fi information and the terms and conditions signed at check in.

13. The method of claim 12, wherein the application further comprises an icons menu that directs the guest to additional detailed information.

14. The method of claim 13, wherein the application further comprises some links to external web pages.

15. The method of claim 8, wherein the host can modify the web information about its listing.
